(19) United States
(12) Patent Application Publication
(10) Pub. No.: US 2016/0291662 A1
(43) Pub. Date: Oct. 6, 2016

(54) INTEGRATED VEHICLE POWER DISTRIBUTION AND CONTROL SYSTEM

(71) Applicants: Daniel Gino Grassetti, Berkeley, CA (US); Sidney Gilbrech, Los Altos, CA (US)

(72) Inventors: Daniel Gino Grassetti, Berkeley, CA (US); Sidney Gilbrech, Los Altos, CA (US)

(21) Appl. No.: 14/923,721

(22) Filed: Oct. 27, 2015

Related U.S. Application Data
(60) Provisional application No. 62/142,639, filed on Apr. 3, 2015.

(51) Int. Cl. G06F 1/26; H04W 4/00

(52) U.S. Cl. CPC G06F 1/266; H04W 4/008

(57) ABSTRACT

A power distribution and control system is provided, comprising: a power input configured to receive current from a vehicle battery; a plurality of switches, each switch operable to control current from the power input to one of a plurality of vehicle circuits; a communications interface; a memory operable to store the programming commands received through the communications interface; and a processor operable to, in response to the immediate commands and the programming commands stored in the memory, selectively control each of the plurality of switches. The communications interface is operable to: receive immediate commands from an external electronic device; receive programming commands from an external electronic device; and transmit circuit status information to the external electronic device.

### RELATED APPLICATION DATA

The present application is related to, and claims the benefit of, commonly-owned and co-pending U.S. Provisional Application Ser. No. 62/142,639, filed on Apr. 3, 2015, and entitled “An integrated system for distributing and controlling electrical power on a boat or vehicle, also providing extensive environmental and performance information to the user. Uses iOS or Android device running our controller application as the interface to our distribution module, communicating via Bluetooth or USB,” which application is incorporated herein by reference in its entirety.

### TECHNICAL FIELD

The present invention relates generally to intelligent device controllers and, in particular, to vehicle power distribution and control systems.

### BACKGROUND ART

Motorized vehicles have several, and often many, devices that require electrical power. Typically, various wiring provides the electrical connection among a battery, a circuit breaker or fuse, a switch, and the device. For some devices, such as heated garments and accessories, a connection is also made with a variable control. Circuit breakers/fuses for all of the devices are commonly located together in one box, which may or may not be in a convenient spot. High current devices, such as high intensity lighting, may require relays or solenoids. Switches and other controls are located within easy reach of the vehicle operator, but some distance away from the battery, the circuit breakers/fuses, and the devices themselves. Warning lights are placed within the view of the operator, but also some distance from the other components of the system. Consequently, cabling and wiring harnesses must be run throughout the vehicle in order to provide all of the necessary connections for each circuit. For a vehicle even with just six circuits, the wiring layout becomes cluttered and adding a new device can become difficult.

### SUMMARY OF THE INVENTION

The present invention provides a power distribution and control system, comprising: a power input configured to receive current from a vehicle battery; a plurality of switches, each switch operable to control current from the power input to one of a plurality of vehicle circuits; a communications interface; a memory operable to store the programming commands received through the communications interface; and a processor operable to, in response to the immediate commands and the programming commands stored in the memory, selectively control each of the plurality of switches. The communications interface is operable to: receive immediate commands from an external electronic device; receive programming commands from an external electronic device; and transmit circuit status information to the external electronic device.

### BRIEF DESCRIPTION OF THE DRAWINGS

FIG. 1A illustrates an embodiment of a power distribution and control module of the present invention with a smartphone with which the module is configurable and controllable;

FIG. 1B is a close-up view of the connection block of the power distribution and control module of FIG. 1A;

FIG. 2 illustrates the main screen of an embodiment of an application running on the smartphone of FIG. 1;

FIG. 3 illustrates the circuit status and adjustment screen of the application of FIG. 2;

FIG. 4 illustrates the circuit setting screen of the application of FIG. 2;

FIG. 5 illustrates the circuit name adjustment screen of the application of FIG. 2;

FIG. 6 illustrates the circuit breaker limit adjustments screen of the application of FIG. 2A;

FIG. 7 illustrates the circuit off delay adjustment screen the application of FIG. 2 configured for a timed delay;

FIG. 8 illustrates circuit off delay adjustment screen the application of FIG. 2 configured for a low voltage trigger;

FIG. 9 illustrates the master electrical status screen of the application of FIG. 2;

FIG. 10 illustrates the voltage alarm setting screen of the application of FIG. 2;

FIG. 11 illustrates the circuit setting screen of the application of FIG. 2 overlaid with an excess current error message;

FIG. 12 illustrates the map screen of the application of FIG. 2;

FIG. 13 illustrates the units of measure adjustment screen of the application of FIG. 2;

FIG. 14A illustrates one set of settings on the automatic circuit adjustment screen accessed from the screen of FIG. 4;

FIG. 14B illustrates another set of settings on the automatic circuit adjustment screen accessed from the screen of FIG. 4;

FIG. 14C illustrates still another set of settings on the automatic circuit adjustment screen accessed from the screen of FIG. 4; and

FIG. 15 is a high-level block diagram of the power distribution module of FIG. 1.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

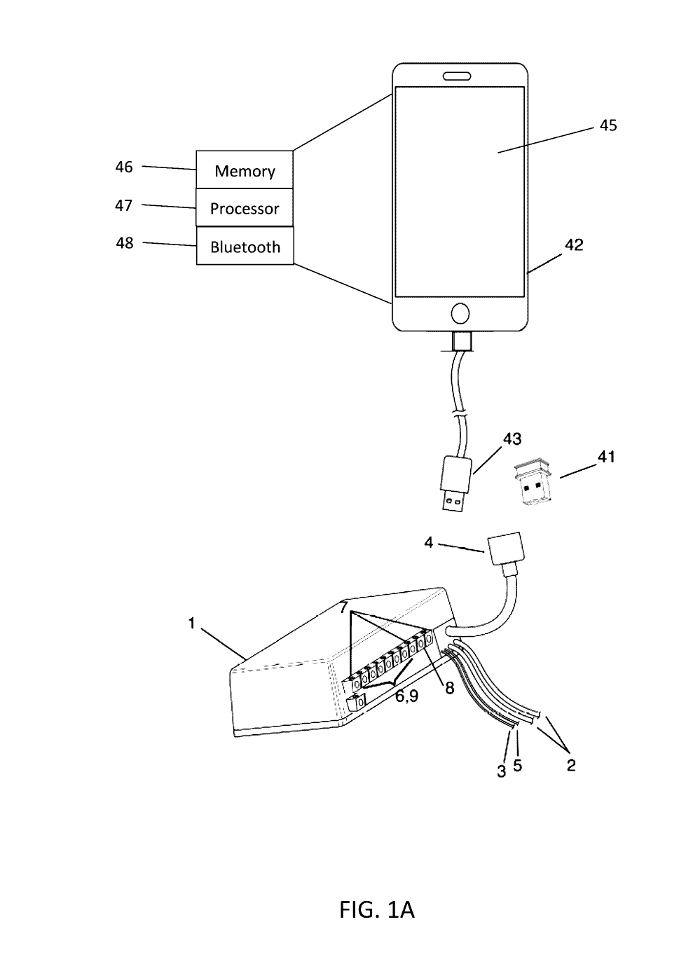

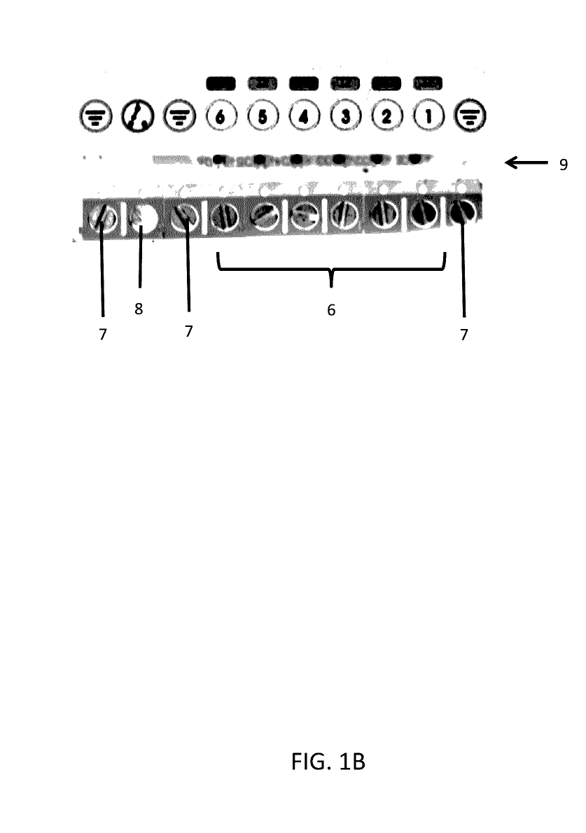

Referring to FIGS. 1A and 1B, the present invention provides an intelligent device controller that includes a small, waterproof and ruggedized microprocessor-controlled power distribution and control module 1 with an accompanying application that runs on a tablet, smartphone, or other electronic device (hereinafter referred to generically as a smartphone 42) to allow the user to configure and control the module 1 through a wired or wireless connection or through voice commands. In one embodiment, the module 1 can provide power to up to six circuits and a total of 60 amps. Multiple modules may be installed, configured, and controlled independently by a single application. In other embodiments, a single module may power more than six circuits and have a maximum capacity greater than 60 amps. As will be more specifically described, the smartphone application allows a user to configure the module 1 for each individual circuit and to control each circuit separately using a wired USB connection or a wireless (such as Bluetooth) connection without discrete wired switches, controls, circuit breakers, or extensive wiring. Circuits may also be controlled automatically according to programmed criteria, allowing circuits to be energized or de-energized based on, for example, ambient temperature or time of day. Other features may allow the user to monitor vehicle electrical performance, ambient temperature, vehicle speed, heading, altitude, time, and position.

The smartphone 42 includes at least a display-touch screen 45, a memory 46 for storing instructions, a processor 47 for executing the instructions stored in the memory 46, and a Bluetooth module 48 which may be paired with the module 1 or a USB interface 43, or both.

In the embodiment illustrated in FIGS. 1A, 1B, the power distribution and control module 1 includes high amperage input lines 2 from the vehicle battery (not shown), a temperature probe 3 for measuring the ambient temperature, a female USB connector 4, a Bluetooth radio module 41, and an ignition status sensor 5. A terminal block includes: six connectors for the powered circuits 6, each connector having a corresponding diagnostic LED 9; three connectors for ground 7; and a connector for a relay switch input 8. In addition, the module 1 includes an input for a battery charger.

Coupling the smartphone 42 with the module 1 may be performed wirelessly using the Bluetooth capabilities of the smartphone 42 paired with an adapter 41 plugged into the USB connector 4, as illustrated in FIG. 1. Alternatively, coupling the smartphone 42 with the module 1 may be made by direct wired connection, mating the USB connector 4 on the module 1 with a dongle plugged into the smartphone 42, as also illustrated in FIG. 1. It will be appreciated that Bluetooth capability may be built into the module 1 and that the USB connector 4 may be a male USB connector to plug directly in the corresponding female connector on the smartphone 42.

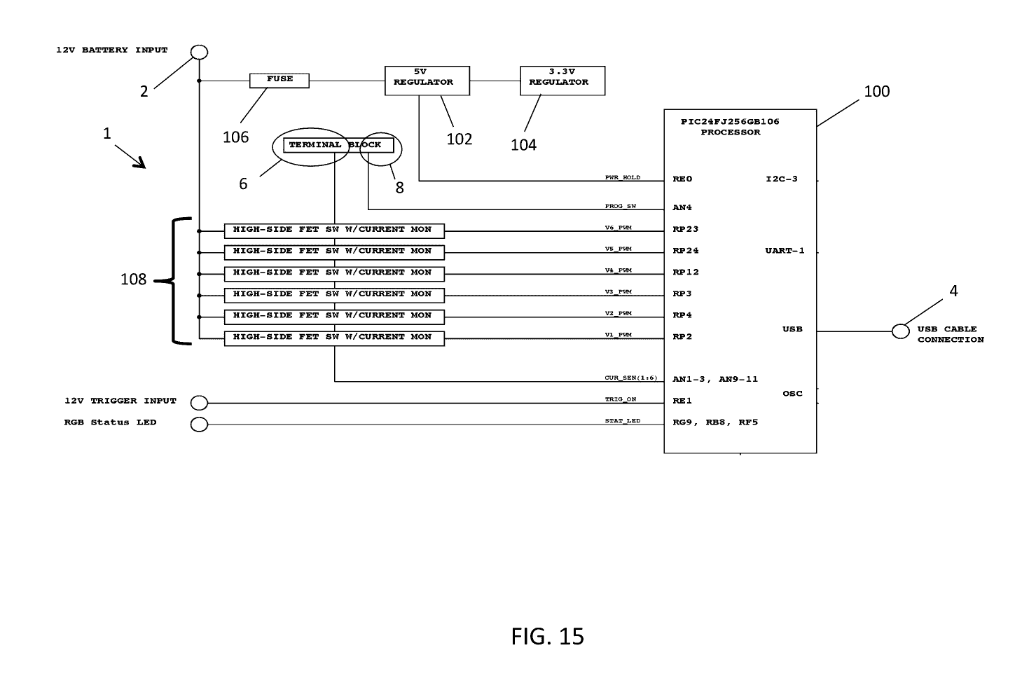

FIG. 15 is a block diagram of an embodiment of the power distribution and control module 1. As shown in the high-level block diagram of FIG. 15, the module 1 includes a processor 100 with internal or external memory, the 12 volt (V) battery input 2, and a 5V regulator 102 (powering the processor 100) coupled through appropriate fusing 106 to the battery input 2. A 3.3V regulator 104 is coupled to the 5V regulator 102. FET switches 108 (six in the illustrated embodiment) are each connected between a pulse width modulated control output (V1_PWM-V6_PWM) on the processor 100 and one of the power connectors 6 (V1-V6) on the terminal block. In the embodiment illustrated, circuits V1 and V5 have a capacity of 12 amps and circuits V3, V4, and V6 have a capacity of 15 amps. While circuit V2 has a capacity of 20 amps, it is designed to handle peaks greater than 20 amps for a short time, a benefit for devices that have high starting current requirements, such as high intensity discharge lights, but that quickly drop down to no more than 20 amps. It will be appreciated that the circuits in other embodiments may be designed to handle greater or lower maximum currents. The USB cable connector 4 among other components are also electrically coupled to the processor 100.

The user may install the module 1 in a convenient location in the vehicle, preferably within two feet of the battery, using any appropriate means, such as double-sided tape, zip-tie, metal band, or screws. Preferably, the module 1 is sealed from the elements, including water and dust. The ambient temperature sensor 3 is mounted in a location where it will detect only the ambient temperature and not be affected by heat from the engine, exhaust, or direct sunlight. The ignition status sensor line 5 is connected to circuit in the vehicle that is energized when vehicle ignition is turned on, such as a tail light wire. If a wired connection to the user's smartphone 42 is desired, the USB adapter cable 43 may be connected from the smartphone to the USB connector 4 on the module 1. Alternatively, the two devices 1, 42 may be wirelessly paired using the Bluetooth adapter 41 plugged into the USB connector 4 (or using Bluetooth technology built into the module 1).

Leads from the various electrical devices to be powered and controlled are connected to the powered circuit connectors 6 on the terminal block and the devices may be grounded by connecting ground leads to the ground connectors 7 or to the vehicle itself. If desired, the user may also connect a battery charger directly to the charger input. In one embodiment, the circuits are energized in sequence. Consequently, it is preferable that high amperage device that will be used immediately upon starting the vehicle be wired to the higher-numbered circuits, allowing full power to start the vehicle. To reduce the risk of short circuits, it is preferable that the positive and negative leads be connected between the battery input 2 and the battery after the other connections are made to the terminal block.

The computer software application for the smartphone 42 may be downloaded from an online site and installed on the smartphone 42 (or other electronic device). The smartphone 42 may then be connected to the power distribution and control module 1 either directly through the USB connector 4 or wirelessly through the Bluetooth adapter 41. The application will be stored in the memory 46 as a set of instructions which will be executed by the processor 47. Various screens provided by the application are presented to the user on the display-touch screen 45, which also accepts touch input from the user.

After all of the connections have been made and the application has been installed on the smartphone 42, the module 1 may be programmed. When the vehicle is switched on, the smartphone will prompt the user to allow it to connect to the module 1 (whether by direct USB connection or wirelessly via Bluetooth). Once connected or paired, the smartphone will upload the current default settings from the module 1 and will begin bi-directional data transfer. The user will then be able to receive real-time information on electrical usage, immediately adjust circuits by providing immediate commands, program circuits by providing programming commands stored in the processor's memory, configure the system, and receive a variety of environmental data.

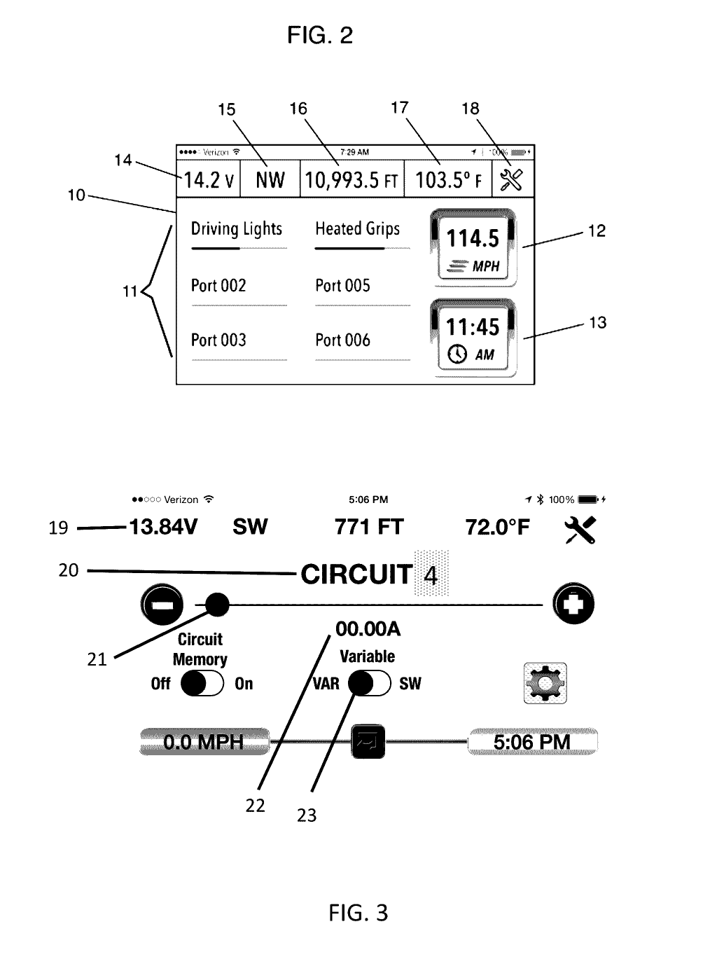

FIGS. 2-14C are examples of various displays presented on the smartphone 42 when the application is used to program and control the module 1. More specifically, FIG. 2 illustrates the main screen 10 of the application running on the smartphone 42 showing the status 11 of each circuit in bar graph of the PWM percent of each circuit. In FIG. 2, two of the circuits have been labeled, which may be done by the user during the initial configuration, and are in use while the remaining four circuits (ports) are inactive. Also displayed are the vehicle speed 12, the current time 13, the current voltage of the battery 14, the vehicle heading 15 and elevation 16, and the ambient temperature 17. The user may also change the units used for the displays through another page 44 (FIG. 13) accessed from the gear icon 18.

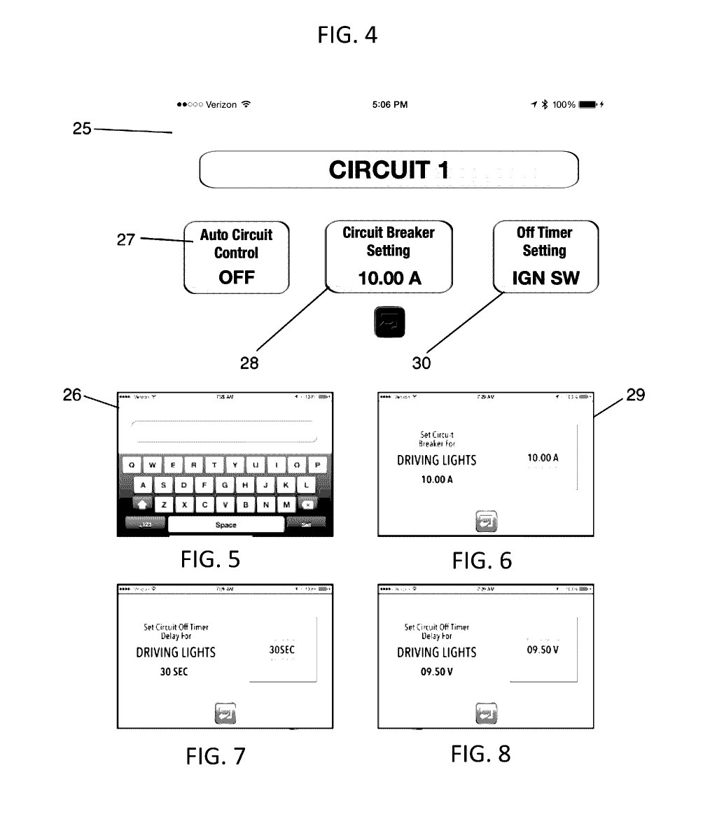

FIG. 3 illustrates the circuit status and adjustment screen 19 of the application. This screen may be accessed from the main screen 10 by pressing the name or number of the desired circuit. The name or number of the circuit 20 is displayed. By selecting the gear icon 18, the circuit configuration screen 25 will be displayed (FIG. 4) allowing the name of the circuit to be entered or changed using the virtual keyboard 26 (FIG. 5). Setting the “circuit memory” switch 27 to the on position allows the circuit to remain in whatever state it was in when the vehicle was last turned off while setting the switch 27 to off allows the circuit to be in the off state when the vehicle is turned on, regardless of its state when the vehicle was last turned off. To set the current at which the circuit's circuit breaker will shut off, the “circuit breaker setting” box 28 is selected and the limit set using a scroll wheel 29 (FIG. 6) or other input method. In FIG. 6, the limit for the driving lights circuit has been set to 10 amps. Lower or higher limits may be selected for devices using less or more current. Selecting the “off timer setting” box 30 allows the user to specify what the circuit does when the vehicle is turned off. Although in the default “IGN SW” setting, the circuit will be switched off when the ignition is turned off, the user may also specify, by means of a scroll wheel or other input method, that the circuit turns off after a selected number of seconds (such as 30 SEC in FIG. 7), minutes, or hours, or when the battery voltage drops to a selected voltage (such as 09.5 V in FIG. 8).

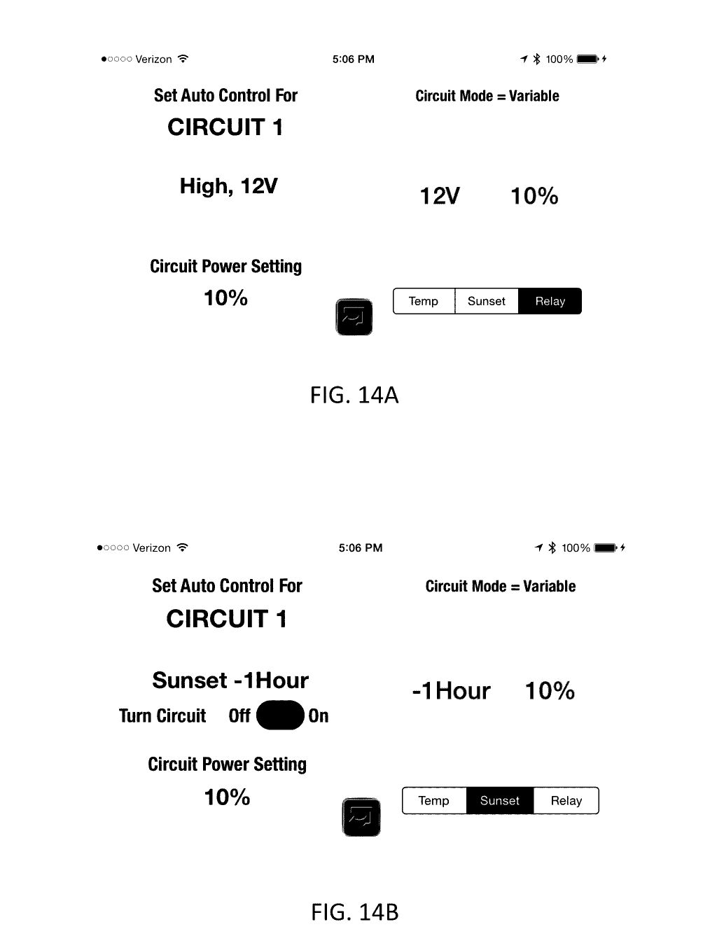

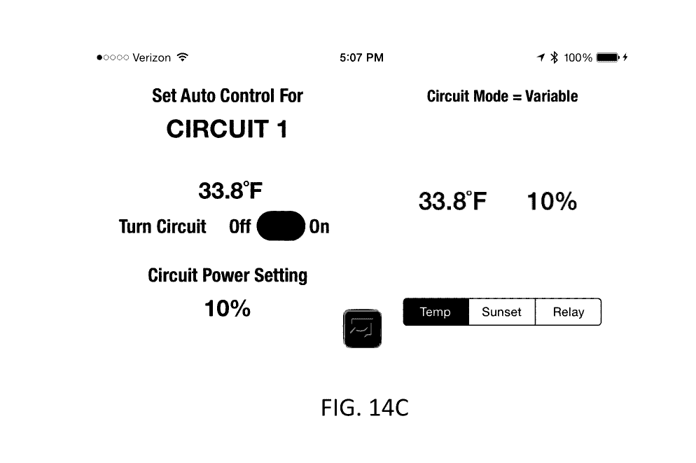

If desired, a circuit may be configured to turn on or off automatically when certain conditions are met. For example, as previously noted, FIG. 4 illustrates a circuit setting screen for a circuit, such as for controlling heated grips. When the “auto circuit control” box is selected, the screen of FIG. 14A may be accessed to adjust the power setting. Alternatively, the heated grips (or any other circuit) may be programmed to turn on or off (either fully on or to some percentage selected by one of the scroll wheels, such as 10% as illustrated in FIG. 14B) when the sun sets (or at some time before or after sunset selected by the other scroll wheel, such as 1 hour before sunset as illustrated in FIG. 14B). The circuit may also be programmed to turn off or on at sunrise (or at some selected time before or after sunrise). Lights may also be conveniently automatically controlled in the same way. A circuit that is automatically turned on at sunset (or at a selected time before or after sunset) will also automatically turn off at sunrise. Sunset and sunrise times may be determined by accessing the appropriate information stored in or accessible by the smartphone 42 or calculated in real-time for any location as the vehicle travels.

In a similar manner, illustrated in FIG. 14C, circuits may be turned on or off (again, either fully or to a predetermined percentage) when the ambient temperature reaches a selected temperature. Such a setting may be used, for example, to have the heated grips or electrically heated clothing turn on or to a selected power percentage when the temperature drops below a specified temperature and turn off when the temperature rises above the specified temperature. In some embodiments, the module 1 may be programmed to automatically vary the power to a circuit in response to changes in the ambient temperature. If the “relay” box is selected, the circuit is activated/deactivated depending on a user-selectable condition of an input line of the module 1: +12V, −12V, or 0. Thus, a circuit may be controlled based on the status of an switch, such as a high beam switch, that is external to the module 1, connected to a terminal 8 of the module 1. Optionally, turn signal pulses may be detected, or the turn signals may be directly coupled to the relay input 8, and the status of the turn signals may be indicated on the smartphone display 45.

If the total amperage selected by the user for all of the circuits exceeds the maximum allowable (60 amps in this embodiment), an error message 40 will be displayed over the circuit setting screen 25, as shown in FIG. 11.

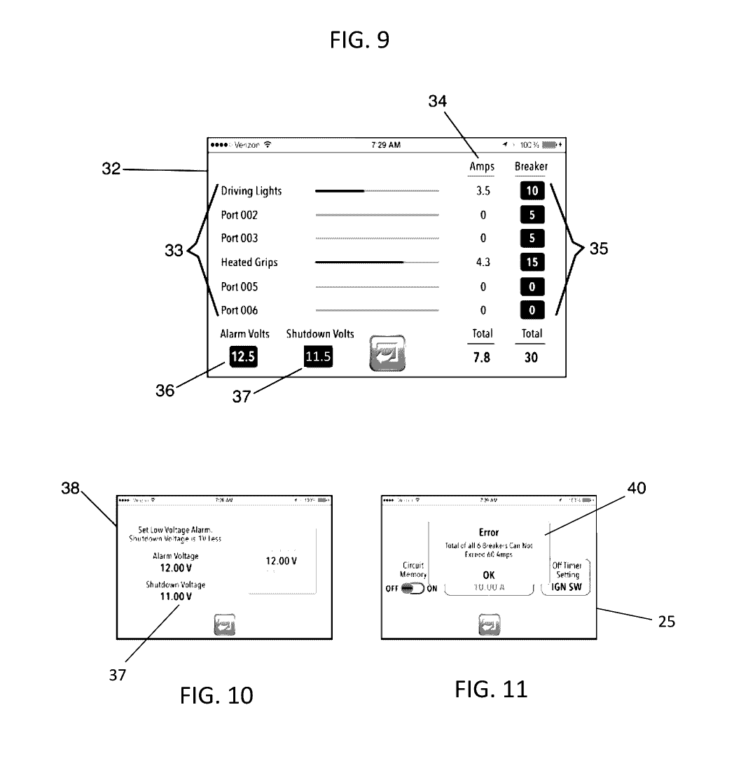

Certain global settings may also be configured by selecting the voltage indicator 14 on the main screen (FIG. 2) to access the master electrical status screen 32, illustrated in FIG. 9. The master electrical status screen 32 allows the user to access another screen 38 (FIG. 10) by selecting the battery voltage 36. In this screen 38, the user may use a scroll wheel to set a voltage below which an alarm will display. Voltage-dependent circuits will be automatically shut down when the voltage drops another volt below the alarm voltage that has been selected. The shut-down voltage is automatically calculated and displayed 37 in FIG. 10.

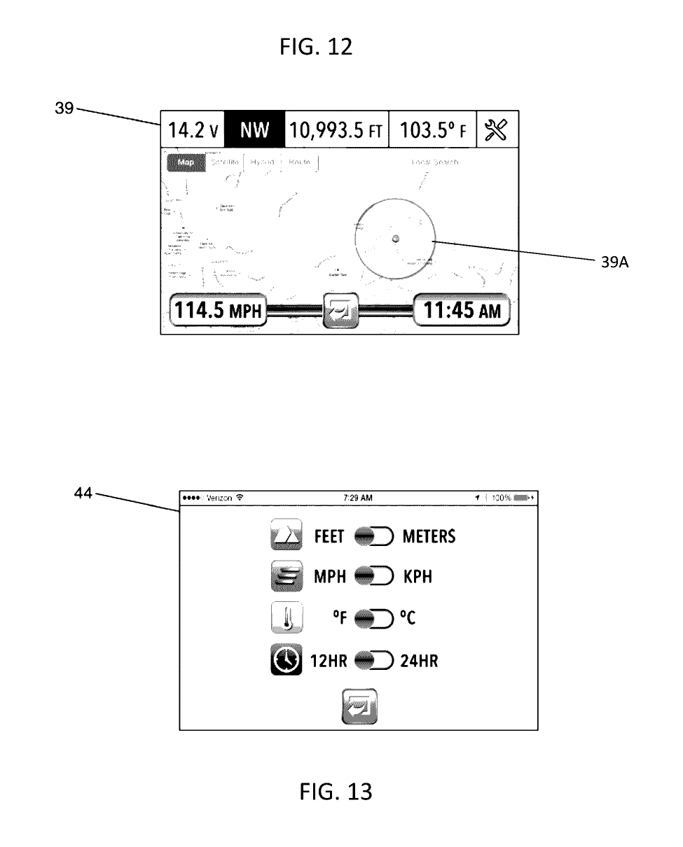

Using GPS location information from the smartphone 42, a map screen 39 may be displayed (FIG. 12), with the current position of the vehicle indicated at the center of a circle 39A. The battery voltage, heading, elevation, temperature, vehicle speed, and time are also displayed on the screen. And, settings may be accessed by selecting the gear icon.

After the module 1 has been configured, the user may display the main screen 10 (FIG. 2) and select any of the active circuits. For example, circuit 4 20, heated grips, may be selected and the circuit adjustment screen 19 is displayed (FIG. 3). For a device that must be either fully on or fully off, such as the HID driving lights, the variable slide switch 23 is set to SW. Selecting the plus (‘+’) button turns the lights on and selecting the minus (‘−⁺’) button turns the lights off. If, instead, the user wanted to control the heated grips, circuit 4, which permits the setting to be variable from full off to fully on, the variable switch 23 may be set to VAR. Selecting the plus button or sliding the slider 21 increases the current flowing to the grips, providing more heat, while selecting the minus button decreases the current, providing less heat. The slider 21 provides a graphical indication of the selected setting while the current 22 is also displayed. In addition to displaying circuit adjustment options, the circuit adjustment screen 19 also displays the same environmental data as the main screen 10.

In addition to the excessive current warning discussed above with respect to FIG. 11, the module 1 provides other warnings. For example, as noted above with respect to the description of FIG. 1, each circuit connector 6 on the terminal block on the module 1 has an associated diagnostic LED 9. An unlit LED indicates that the corresponding circuit is not energized. An amber LED indicates that the circuit is energized and has no faults. A red LED indicates that the circuit is shorted. And, a flashing red LED indicates that the circuit has been overloaded. Similar warnings are transmitted by the module 1 and displayed on the smartphone 42. Low voltage alarm notifications are shown on the smartphone display.

In addition to the module 1 operating with the while connected to the smart phone 42, including providing and responding to all of the environmental and electrical status info, the module 1 may also function in a stand-alone mode. In this mode, the module 1 automatically controls the electrical functions that were previously programmed without any further operator or smartphone 42 involvement. These functions may include, but are not limited to:
turning on or off circuits when the ambient temperature drops to a user-defined level. This feature is particularly useful for automatically activating heated accessories and clothing at predetermined temperatures. For example, the module 1 may be programmed to automatically turn on heated grips at 64 degrees, a heated jacket at 58 degrees, heated gloves at 54 degrees, and (for truck use) turn off a refrigerator when the ambient temperature drops to 72 degrees;
turning on or off circuits when the time of day suggests this is prudent, which is particularly useful for automatically activating lighting;
turning accessory circuits on or off when, for example, an OEM circuit is activated of deactivated using the relay functionality;
turning circuits off when amperage levels have exceeded a predetermined level or in response to a short circuit;
turning circuits off when battery voltage drops below a programmed level;
leaving circuits on for programmed periods of time after the vehicle has been shut down; and
upon returning a circuit to the state it was in when the vehicle was shutdown/restart cycle or returning the circuit to the off state.

The user may install and separately program multiple modules to program and monitor different functions or functions on different vehicles. As soon as the smartphone 42 application connects with a particular module, the application will download and reflect the functions that were programmed on that module, allowing for monitoring and re-programming those functions. Unless reprogrammed, functions in a module will remain in effect so that use of the application, or connection with the smartphone 42, is not necessary after the module has been programmed.

The description of the present invention has been presented for purposes of illustration and description, but is not intended to be exhaustive or limited to the invention in the form disclosed. Many modifications and variations will be apparent to those of ordinary skill in the art and it will be appreciated that the screens illustrated and described herein meant to be representative and not limiting or exhaustive. The embodiment was chosen and described in order to best explain the principles of the invention, the practical application, and to enable others of ordinary skill in the art to understand the invention for various embodiments with various modifications as are suited to the particular use contemplated.

What is claimed is:

1. A power distribution and control system, comprising:
a power input configured to receive current from a vehicle battery;
a plurality of switches, each switch operable to control current from the power input to one of a plurality of vehicle circuits;
a communications interface operable to:
receive immediate commands from a connected external electronic device;
receive programming commands from the external electronic device; and
transmit circuit status information to the external electronic device for display to a user;
a memory operable to store the programming commands received through the communications interface; and
a processor operable to selectively control each of the plurality of switches in response to the immediate commands and the programming commands stored in the memory.

2. The power distribution and control system of claim 1, further comprising a sensor configured to detect the status of the vehicle ignition.

3. The power distribution and control system of claim 1, wherein the communications interface comprises a Bluetooth interface.

4. The power distribution and control system of claim 1, wherein the communications interface comprises a wired USB interface.

5. The power distribution and control system of claim 1, the immediate commands comprise commands for:
turning on or off a user-selected vehicle circuit; and
adjusting the current to a user-selected vehicle circuits.

6. The power distribution and control system of claim 1, the programming commands stored in the memory comprise commands for:
setting a maximum allowable current to a user-selected vehicle circuit.

7. The power distribution and control system of claim 1, further comprising an ambient temperature sensor.

8. The power distribution and control system of claim 7, the programming commands stored in the memory comprise commands for:
turning on or off a user-selected vehicle circuit at a user-selected ambient temperature; and
adjusting the current of a user-selected vehicle circuit in response to ambient temperature.

9. The power distribution and control system of claim 1, the programming commands stored in the memory comprise commands for:
turning on or off a user-selected vehicle circuit at a user-selected time;
turning on a user-selected vehicle circuit at sunset; and
turning off a user-selected vehicle circuit at sunrise.

10. The power distribution and control system of claim 1, further comprising an ignition status sensor.

11. The power distribution and control system of claim 10, the programming commands stored in the memory comprise commands for:
setting a time during which a user-selected vehicle circuit will remain on after the vehicle ignition is turned off; and
setting a battery voltage above which a user-selected vehicle circuit will remain on after the vehicle ignition is turned off.

12. The power distribution and control system of claim 10, the programming commands stored in the memory comprise commands for:
enabling a circuit memory whereby the state of a user-selected circuit when the vehicle ignition is turned off is restored when the vehicle ignition is subsequently turned on; and
disabling a circuit memory whereby a user-selected circuit is in an off state when the vehicle ignition is turned on.

13. The power distribution and control system of claim 1, further comprising a switch state sensor operable to detect a state of an external switch.

14. The power distribution and control system of claim 13, the programming commands stored in the memory comprise commands for:
turning on or off a user-selected vehicle circuit in response to the state of the external switch.

15. The power distribution and control system of claim 1, wherein the external electronic device is configured to display to the user environmental information comprising at least one of ambient temperature, current location, current time, heading, and elevation.

16. The power distribution and control system of claim 1, wherein after programming commands have been stored in the memory, the programming commands are executable by the processor without connection with the electronic device.

17. The power distribution and control system of claim 1, wherein control of the plurality of switches comprises providing at least one of the vehicle circuits with a pulse width modulated (PWM) current.
